(19) United States
(12) Patent Application Publication
(10) Pub. No.: US 2021/0342430 A1
(43) Pub. Date: Nov. 4, 2021

(54) IDENTITY VERIFICATION USING TASK-BASED BEHAVIORAL BIOMETRICS

(71) Applicant: Capital One Services, LLC, McLean, VA (US)

(72) Inventors: Abdelkader M'Hamed BENKREIRA, New York, NY (US); Andrea MONTEALEGRE, Arlington, VA (US); Daniel MARSCH, Arlington, VA (US); Nagaraju GADDIGOPULA, Herndon, VA (US); William PRIOR, Richmond, VA (US); Phoebe ATKINS, Brooklyn, NY (US)

(21) Appl. No.: 16/864,834

(22) Filed: May 1, 2020

(51) Int. Cl. G06F 21/32; G06N 5/04; G06F 21/36; H04L 29/06; H04W 12/06; G06N 20/00

(52) U.S. Cl. CPC G06F 21/32; G06N 5/04; G06N 20/00; H04L 63/0861; H04W 12/06; G06F 21/36

(57) ABSTRACT

A system may receive a request to verify an identity of a user. The system may transmit information that identifies a task to be performed via user interaction with a client device and information that identifies behavioral data to be collected by the client device in connection with performance of the task, wherein the task requires at least one of: movement of the client device, interaction with a user interface of the client device using a gesture, or interaction with a user interface of the client device using a cursor. The system may receive the behavioral data and may perform identity verification associated with the user based on the behavioral data and the task. The system may transmit an indication of a recommended action to be performed with respect to the user and the client device based on performing the identity verification.

### BACKGROUND

Identity verification involves actions taken to prevent undesirable access to a user's secure area by confirming that the user is the user the secure area is associated with. Identity verification may include directing the user to complete a task to obtain access to a secure area. Common tasks may include providing authentication information, such as a username, password, personal identification number (PIN), and/or other authentication information. This may help prevent unauthorized access to the user's secure area.

### SUMMARY

According to some implementations, a method may include receiving, by a system, a request to verify an identity of a user; transmitting, by the system, information that identifies a task to be performed via user interaction with a client device and information that identifies behavioral data to be collected by the client device in connection with performance of the task, wherein the task requires at least one of: movement of the client device, interaction with a user interface of the client device using a gesture, or interaction with a user interface of the client device using a cursor; receiving, by the system, the behavioral data, wherein the behavioral data is collected by the client device during performance of the task via user interaction with the client device, wherein the behavioral data includes at least one of acceleration data, pressure data, or temperature data; performing, by the system, identity verification associated with the user based on the behavioral data and the task, wherein the identity verification is performed using a machine learning model that identifies patterns associated with the behavioral data and the task; and transmitting, by the system, an indication of a recommended action to be performed with respect to the user and the client device based on performing the identity verification.

According to some implementations, a system may include one or more memories; and one or more processors, communicatively coupled to the one or more memories, configured to: transmit information that identifies behavioral data to be collected by a client device in connection with performance of an identity verification task to be performed via user interaction with the client device, wherein the identity verification task requires at least one of: movement of the client device, or interaction with a user interface of the client device using a gesture or a cursor; receive the behavioral data, wherein the behavioral data is collected by the client device during performance of the identity verification task via the user interaction with the client device; provide the behavioral data and a task identifier, that identifies the identity verification task, as a feature set that is input to a machine learning model; receive output from the machine learning model; and cause a recommended action to be performed with respect to verifying an identity of a user of the client device based on the output from the machine learning model.

According to some implementations, a non-transitory computer-readable medium may store one or more instructions. The one or more instructions, when executed by one or more processors of a system, may cause the one or more processors to: transmit information that identifies: a task to be performed to verify an identity of a user of a client device, and behavioral data to be collected by the client device during performance of the task, wherein the task requires at least one of: movement of the client device, or interaction with a user interface of the client device using a gesture or a cursor; receive the behavioral data, wherein the behavioral data includes at least one of an acceleration parameter, a speed parameter, a force parameter, a directional parameter, a position parameter, a pressure parameter, or a temperature parameter; generate a feature set based on the behavioral data; determine an identity verification score based on a degree of similarity of the feature set and one or more other feature sets associated with the user; and cause a recommended action to be performed with respect to the client device based on the identity verification score.

### BRIEF DESCRIPTION OF THE DRAWINGS

FIGS. 1A-4 are diagrams of one or more example implementations described herein.

FIG. 5 is a diagram of an example environment in which systems and/or methods described herein may be implemented.

FIG. 6 is a diagram of example components of one or more devices of FIG. 5.

FIGS. 7-9 are flowcharts of example processes for identity verification using task-based behavioral biometrics.

### DETAILED DESCRIPTION

The following detailed description of example implementations refers to the accompanying drawings. The same reference numbers in different drawings may identify the same or similar elements.

Identity verification involves actions taken to prevent undesirable access to a user's secure area by requiring proof of the user's identity. Identity verification may include requiring the completion of tasks. A successful completion of tasks may confirm the user's identity to a third party in order for the user to obtain access to a secure area. Secure areas may include both physical areas (such as buildings, vehicles, and/or the like) and nonphysical areas (such as bank accounts, websites, and/or the like). Common tasks may include providing authentication information, such as a username, password, PIN, and/or the like to prove the user's identity, because such authentication information may be assumed to be known only by the user.

However, some tasks may be easily completed by other parties who have illegitimately obtained enough information about the user to pose as the user. For example, a fraudulent actor who steals the user's authentication information (e.g., a username, a password, a birthdate, an address, and/or the like) may obtain access to the user's secure area if the task is to provide this particular authentication information. Fraudulent actors (which may include bots) that are able to crack secure databases and obtain authentication information on users may be able to compromise many users' secure areas by posing as the users using the illegitimately obtained authentication information.

Illegitimate access to the users' secure areas wastes resources in numerous ways. Providers (who provide the goods and/or services to the users) may attempt to identify, diagnose, and remedy errors due to allowing unauthorized access to the users' secure areas. For example, providers may use computing resources (e.g., processor resources, memory resources, storage resources, and/or the like) associated with reversing an illegitimate transaction that resulted from incorrect identity verification. In another example, computing resources may be used to update a system (e.g., prompting user to provide alternative authentication information, and/or the like) to prevent future unauthorized access.

Some implementations described herein provide an identity verification platform that verifies a user's identity using task-based behavioral biometrics. The identity verification platform may detect illegitimate access by analyzing behavioral data obtained from a user completing a biometric task using a client device. The behavioral data may include measurements of force, acceleration, temperature, and/or the like of the user interacting with the client device to complete a task. This behavioral data may be unique to each user and difficult for an illegitimate user to imitate, allowing the identity verification platform to successfully verify an identity and/or detect illegitimate access. This may result in accurate identity verification, which in turn saves computing resources associated with identifying, diagnosing, and remedying illegitimate activity after the fact (e.g., after the illegitimate activity occurs). For example, computing resources used to reverse an illegitimate transaction that resulted from incorrect identity verification may be saved.

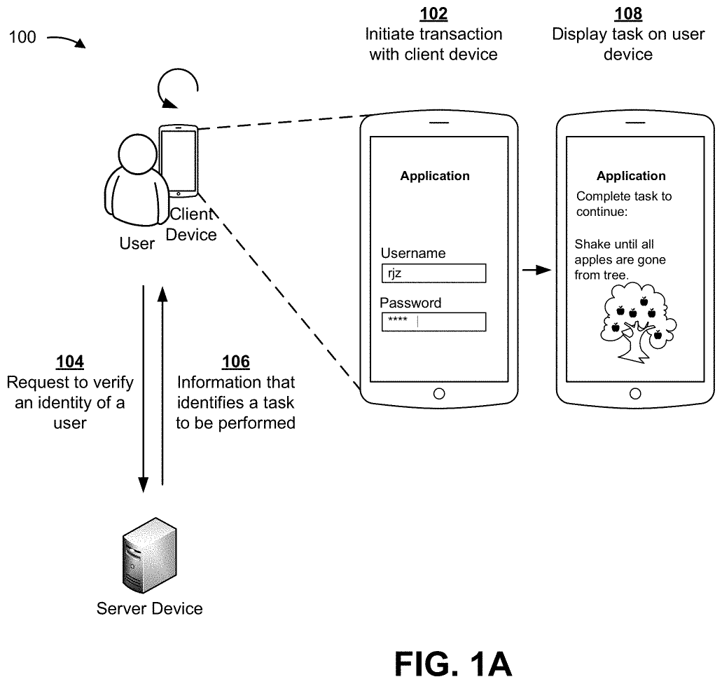

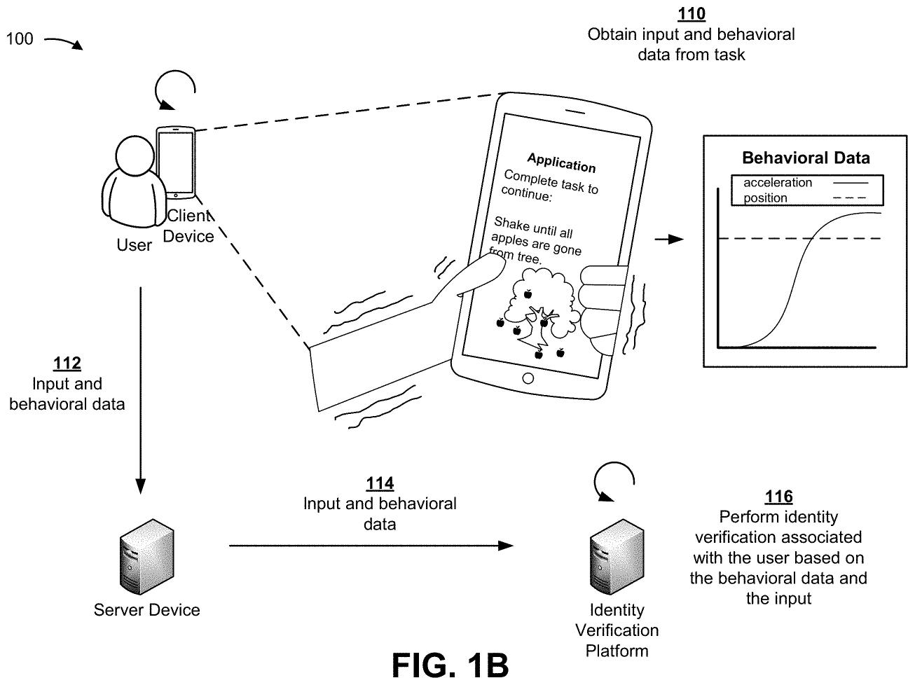

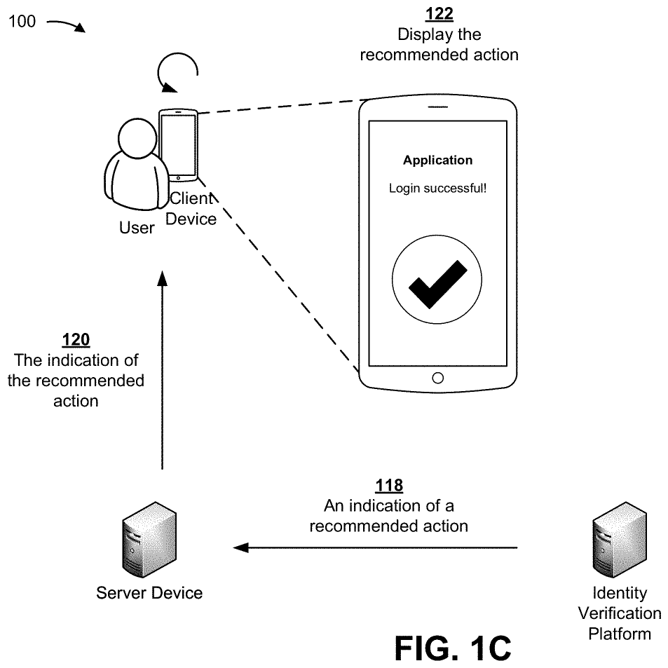

FIGS. 1A-1C are diagrams of one or more example implementations 100 described herein. As shown in FIGS. 1A-1C, a client device may be associated with a user, a server device, and an identity verification platform. The user of the client device may interact with the client device to conduct a transaction with the server device. The server device may be configured to send and/or receive information from the identity verification platform, which performs identity verification based on analyzing information received by the identity verification platform. The server device may transmit information to the client device based on recommended actions from the identity verification platform.

As shown in FIG. 1A, and by reference number 102, the user may use the client device to initiate the transaction associated with the server device. For example, the user may use the client device to interact with an application provided by or otherwise associated with the server device. The application may provide access to a user's secure area associated with the server device (e.g., bank account information, billing information, and/or the like). While interaction with an application is displayed in the figures, any type of transaction, service, and/or the like may be relevant to this example. The transaction may be accessed via a webpage, application, and/or the like on the client device.

In some implementations, the client device may have sensors to obtain behavioral data from the user interacting with the client device. Behavioral data may include any information from the user interacting with the client device. This may include various types of data associated with the user moving the client device (e.g., force data, acceleration data, velocity data, directional data, positional data, and/or the like). For example, if the user is shaking the client device, a client device gyroscope and/or another sensor may be used to obtain data for directional acceleration, force acceleration, directional change, client device positionality, and/or the like. Additionally, or alternatively, sensors may capture acceleration data, position data, and/or the like from a user interacting with the client device using gestures. In some implementations, the behavioral data may include various types of data associated with the user interacting with a screen of the client device (e.g., speed, path, jiggle, pressure, temperature, path, and/or the like). For example, if the user swipes a finger across a screen on the client device, the client device sensors may obtain data of a path of the swipe, a pressure associated with the finger swipe, a temperature of the finger placed on the screen, a size associated with the finger area touching the screen, and/or the like.

Additionally, or alternatively, the behavioral data may include other information associated with the user interacting with the client device or information associated with the user completing a task on the client device, such as a height of the client device when the user is holding the client device, a detected object the user uses to interact with the client device (e.g., a mouse, a touchscreen, a stylus, a finger, and/or the like), and/or the like. In some implementations, the behavioral data may include timing information (e.g., time associated with completing a task, and/or the like). In some implementations, the behavioral data may include types of behavioral data as a function of time (e.g., acceleration over time, pressure over time, force over time, and/or the like). The examples for behavioral data are listed merely as illustrative examples and are not intended to limit the scope of what may be considered to be behavioral data.

In some implementations, through initiating the transaction with the client device, the user may input information preliminarily identifying the user. For example, the user may input authentication information (e.g., a username, password, PIN, and/or the like) to the client device. As shown in FIG. 1A, and by reference number 104, the client device may send a request to verify an identity of the user to the server device. Based on receiving the request, the server device may determine to send information that identifies a task to be performed by the user to confirm the identity of the user. Tasks may encompass a wide variety of activities for the user to interact with the client device and provide behavioral data to be collected by the client device. In some implementations, tasks may include gamified methods that direct the user to interact with the client device in ways that allow the client device to obtain the behavioral data. Tasks may include movement of the client device, interaction with a user interface of the client device using a gesture, interaction with the user interface of the client device using a cursor, and/or the like.

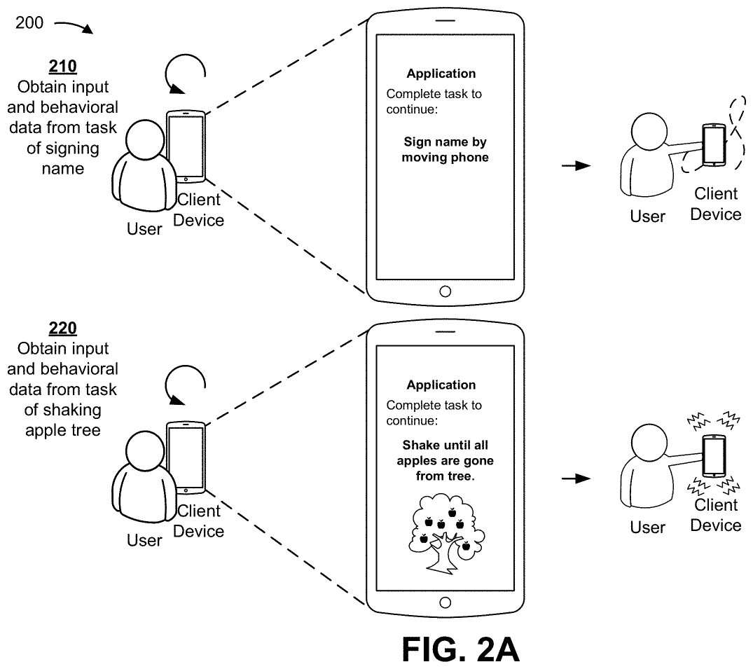

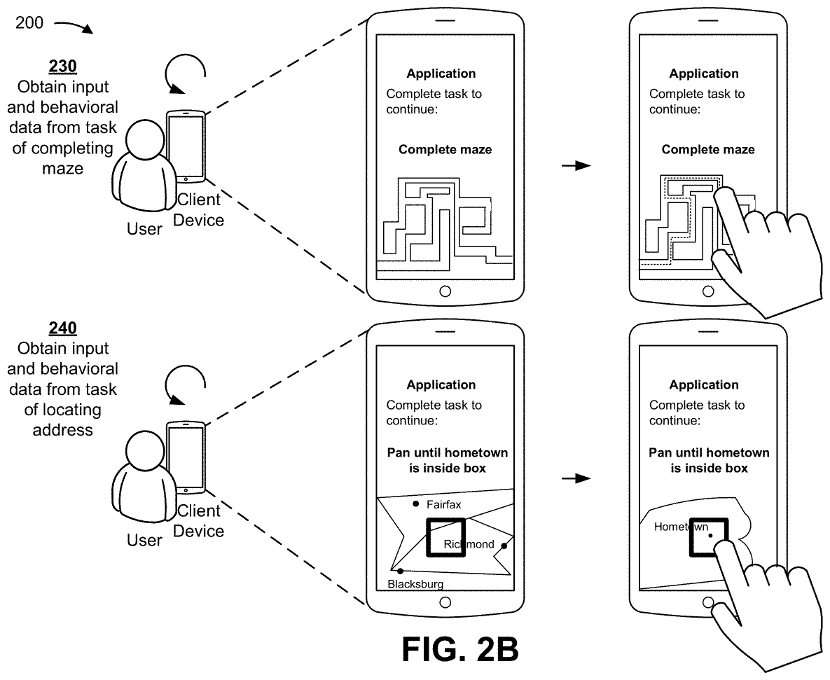

For example, a task may include moving the client device in a particular way to complete the task (e.g., shaking the client device until apples on an apple tree displayed on a screen of the client device have all fallen off the apple tree, forming a signature in the air by moving the client device, and/or the like). In some implementations, the task may include the user interacting with the screen of the client device to complete the task (e.g., completing a maze displayed on the screen by drawing the path on the screen from start to finish, panning a map displayed on the client device until a particular location is displayed in the center of the screen, and/or the like). In some implementations, the task may include interacting with the client device using another device (e.g., a mouse, a touchpad, a stylus, and/or the like). For example, the task may include signing a name by clicking and moving a mouse associated with the client device, shaking an apple tree displayed on a screen of a client device my clicking and moving a mouse, and/or the like. In some implementations, the task may be associated with knowledge-based authentication (KBA). For example, a task may include panning a map displayed on the client device until a location particular to the user (e.g., the user's hometown, the user's billing address, the user's current address, and/or the like) is displayed in the center of the screen. FIGS. 2A-2B depict several examples of the tasks that may be performed by the user.

Behavioral data, previously described in relation to FIG. 1A, may be collected for each task. In some implementations, different types of behavioral data may be collected for each type of task. Particular types of behavioral data may be associated with particular types of tasks in a way that outputs behavioral data that exhibits a unique footprint for the user. For example, a speed associated with the user forming a signature by moving the client device through the air may be particularly helpful in differentiating the user from other users. In a contrasting example, temperature data for particular tasks may not be particularly useful in distinguishing users for some tasks since temperature data may be similar for many users, or too variable for one user to create a unique footprint for the user.

Information regarding the tasks may be stored on the server device or stored on a storage device accessible by the server device, the client device, and/or the identity verification platform. Tasks may be grouped together or classified with other similar tasks. For example, tasks that are associated with particular behavioral data may be grouped together by behavioral data. In another example, tasks with a similar goal may be grouped together (e.g., tasks that require movement of the client device, tasks that require interaction with the user interface of the client device using a gesture, tasks that require interaction with the user interface of the client device using a cursor, and/or the like).

The server device may determine a type of task to send by selecting a task from a set of tasks, causing a new task to be generated, and/or the like. The server device may determine a type of task to send based on different factors. For example, the server device may determine to send a similar type of task to the client device that the user has previously completed in order to obtain more data points for particular types of behavioral data. In some implementations, the server device may determine to send a task that is substantially different from tasks previously completed by the user, if the server device has determined that the previously completed tasks did not output useful behavioral data. While the figures illustrate the server device performing the determination, another device (the client device, the identity verification platform, and/or the like) may perform the determination or part of the determination.

As shown in FIG. 1A, and by reference number 106, the server device may send information identifying a task to be performed to the client device. The information identifying the task to be performed may cause the client device to display information regarding the task. As shown in FIG. 1A, and by reference number 108, the client device may display information regarding the task to the user. For example, the client device may display a screen with an apple tree (e.g., a tree with apples) and direct the user to shake the client device until all the apples have fallen off the tree. As the user shakes the client device, the display may be animated to depict one or more apples falling off the tree. In some implementations, the apples may be animated to fall off based on a particular movement, force, velocity, acceleration, and/or the like associated with the client device. Based on observing the display, the user may determine to move the client device in a particular way (e.g., slowly, quickly, with small movements, with large movements, and/or the like). The user may complete the task displayed by the client device.

As shown in FIG. 1B, and by reference number 110, the client device may obtain the input and behavioral data associated with the user completing the task. The behavioral data may include any of the types of data described in connection with FIG. 1A. The input may indicate a completion of the task, an answer to the task (e.g., an answer to a KBA task), and/or the like. In some implementations, the input may include various other types of data input by the user or detected by the client device (e.g., a location associated with the client device, a time associated with the client device, and/or the like).

As shown in FIG. 1B, and by reference number 112, the client device may send the input and the behavioral data to the server device. The server device may verify that the input is correct. In some implementations, the server device may process the input and/or the behavioral data in preparation for another device to process the input and/or the behavioral data. For example, the client device may aggregate the input and/or the behavioral data with other input and/or behavioral data, format the input and/or the behavioral data, and/or the like to assist the identity verification platform in processing the input and/or the behavioral data. As shown in FIG. 1B, and by reference number 114, the server device may send the input and/or the behavioral data to the identity verification platform.

As shown in FIG. 1B, and by reference number 116, the identity verification platform may perform identity verification associated with the user based on receiving the input and/or the behavioral data. The identity verification platform may determine to verify the user's identity, determine to not verify the user's identity, determine there is not enough information to verify the user's identity, determine a likelihood that the user's identity should be verified, determine an identity verification score, and/or the like. The identity verification platform may perform the identity verification in various ways. In some implementations, the identity verification platform may compare the input and/or the behavioral data with past input and/or behavioral data associated with the user. Input and/or behavioral data that is different (or different to a particular threshold) from the past input and/or behavioral data may indicate that the user's identity is not to be verified. For example, if past behavioral data indicates that a user applies a light force when shaking the client device, behavioral data that indicates a particularly rigorous force was applied when shaking the client device may be indicative of fraud. In some implementations, some input and/or behavioral data may indicate illegitimate access (and that the user's identity should not be verified) for any user. For example, behavioral data that indicates the user is taking a long time (e.g., a time longer than a particular threshold) to complete the task may indicate that the user's identity should not be verified. In some implementations, the identity verification platform may associate particular types of input and/or behavioral data with illegitimate access (and thus should not result in verification) based on processing input and/or behavioral data from other users.

In some implementations, the identity verification platform may determine user attributes from the input and/or the behavioral data. The user attributes may include various information that is to be associated with the user interacting with the client device. Some user attributes may have a high potential to accurately indicate identity verification, while some user attributes may have a low potential to accurately indicate identity verification. The identity verification platform may analyze and combine determinations for each user attribute to determine whether to verify the user. Depending on how the user attribute is weighted, one potentially illegitimate user attribute may not outweigh multiple legitimate user attributes, one potentially illegitimate user attribute may outweigh multiple legitimate user attributes, and/or the like.

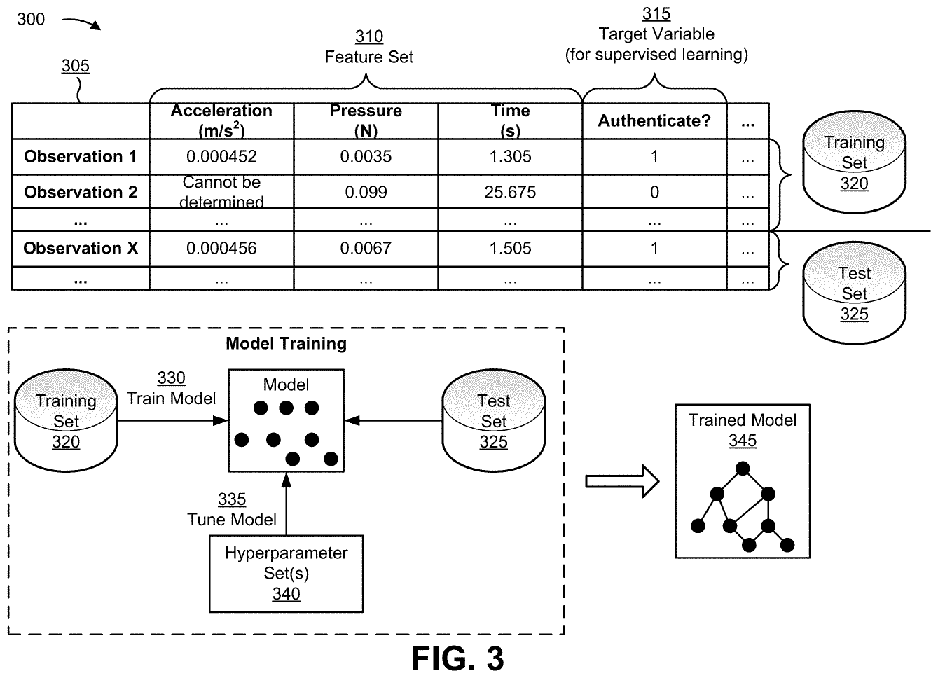

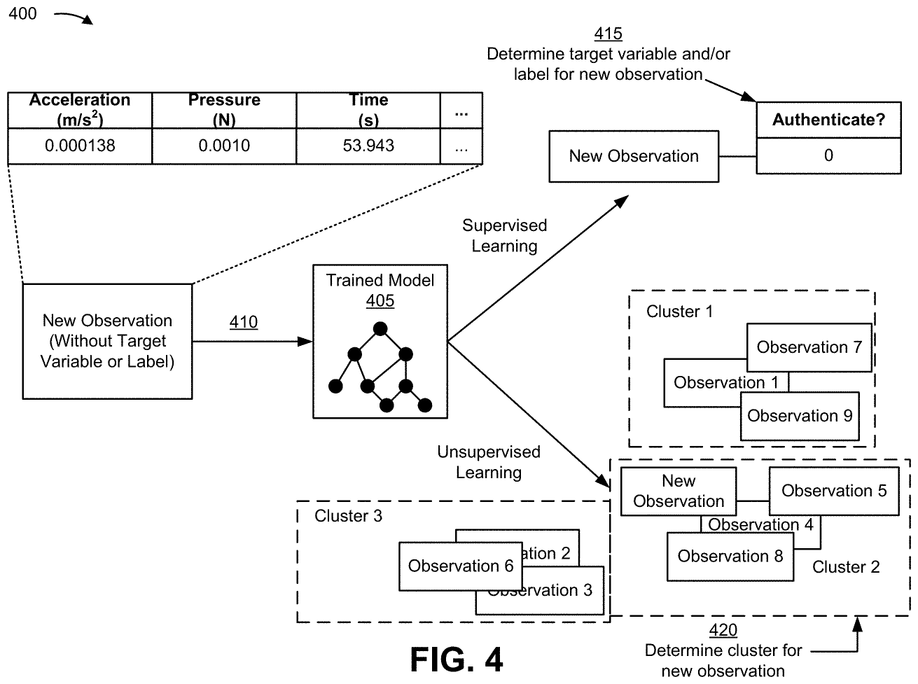

In some implementations, the identity verification platform may use machine learning to perform the identity verification. For example, the identity verification platform may use machine learning to determine whether a user attribute is indicative of legitimate activity, use machine learning to determine how to assign a weight to the user attribute, and/or the like. The machine learning implementation is described in more detail below in relation to FIGS. 3-4.

Based on performing identity verification, the identity verification platform may determine a recommended action. Recommended actions may include allowing access to a resource, blocking access to a resource, sending an additional task, requesting additional data from the client device, and/or the like. As shown in FIG. 1C, and by reference number 118, the identity verification platform may transmit an indication of the recommended action to the server device. The server device may perform processing on the indication of the recommended action. As shown in FIG. 1C, and by reference number 120, the server device may send the indication of the recommended action to the client device. As shown in FIG. 1C, and by reference number 122, the client device may display the recommended action. For example, the client device may display a notification that the identity verification, authentication, and/or the like was successful. In some implementations, the client device may allow access to the resource, secure area, and/or the like. Recommended actions may include denying access to the resource, secure area, and/or the like; requesting additional data; and/or the like (such as what was described in relation to FIG. 1B).

As indicated above, FIGS. 1A-1C are provided as one or more examples. Other examples may differ from what is described in connection with FIGS. 1A-1C. The number and arrangement of devices shown in FIGS. 1A-1C are provided as one or more examples. In practice, there may be additional devices, fewer devices, different devices, or differently arranged devices than those shown in FIGS. 1A-1C. Furthermore, two or more devices shown in FIGS. 1A-1C may be implemented within a single device, or a single device shown in FIGS. 1A-1C may be implemented as multiple, distributed devices. Additionally, or alternatively, a set of devices (e.g., one or more devices) of FIGS. 1A-1C may perform one or more functions described as being performed by another set of devices of FIGS. 1A-1C.

FIGS. 2A-2B are diagrams of one or more example implementations 200 described herein. As shown in FIG. 2A, and by reference number 210, a task may include directing the user to complete the task by signing the user's name by moving the client device to form the signature. The user may move the client device to draw out the signature. In some implementations, the user may use a mouse to click and hold as the user draws out the signature using the mouse. The client device may collect behavioral data as the user completes the task. The behavioral data collected by the client device may include directional acceleration, force acceleration, direction change, client device positionality, time taken to complete the signature, and/or the like. In some implementations, the behavioral data may be collected as a function of time (e.g., directional acceleration over time, force acceleration over time, direction change over time, client device positionality over time, and/or the like).

As shown in FIG. 2A, and by reference number 220, a task may include displaying a tree with apples on a screen of the client device and directing the user to shake the apple tree until a threshold number of apples have fallen off the tree. The user may shake the apple tree by shaking the client device, using a mouse to click and hold the apple tree and shake the apple tree using the mouse, and/or the like. The client device may obtain various behavioral data from the user completing the task, such as directional acceleration, force acceleration, direction change, client device positionality, and/or the like. In some implementations, the behavioral data may be collected as a function of time (e.g., directional acceleration over time, force acceleration over time, direction change over time, client device positionality over time, and/or the like).

As shown in FIG. 2B, and by reference number 230, a task may include displaying a maze on a screen of the client device and directing the user to complete the maze (e.g., draw a line from a start opening of the maze to a finish opening of the maze). The user may complete the task by using a finger, a stylus, and/or the like to draw a path on the maze displayed on the screen of the client device from start to finish. In some implementations, the user may use a mouse and/or another device to click and hold to draw the path. The client device may obtain various behavioral data from the user completing the task, such as speed, path, jiggle, pressure (e.g., a pressure associated with a finger touching the screen of the client device), temperature (e.g., a temperature associated with a finger touching the screen of the client device), directional acceleration, force acceleration, direction change, client device positionality, and/or the like. In some implementations, the behavioral data may be collected as a function of time (e.g., speed over time, pressure over time, jiggle over time, directional acceleration over time, force acceleration over time, direction change over time, client device positionality over time, and/or the like).

As shown in FIG. 2B, and by reference number 240, a task may include displaying a map on a screen of the client device and directing the user to drag the map such that a location is inside a designated area (e.g., a fixed square) displayed on the screen of the client device. In some implementations, the location may be associated with the user (e.g., a hometown, a current address, a billing address, and/or the like). The user may complete the task by using a finger, a stylus, and/or the like to position the map (e.g., by panning, zooming, dragging, and/or the like), until a particular location is in the designated area displayed on the screen. In some implementations, the user may use a mouse and/or another device to position the map. The client device may obtain various behavioral data from the user completing the task, such as speed, path, time to complete the task, and/or the like. In some implementations, the behavioral data may be collected as a function of time (e.g., speed over time, path over time, and/or the like).

As indicated above, FIGS. 2A-2B are provided as one or more examples. Other examples may differ from what is described in connection with FIGS. 2A-2B.

FIG. 3 is a diagram illustrating an example 300 of training a machine learning model. The machine learning model training described herein may be performed using a machine learning system. The machine learning system may include a computing device, a server, a cloud computing environment, and/or the like, such as a client device (e.g., as described in connection with FIGS. 1A-2B), a server device (e.g., as described in connection with FIGS. 1A-2B), and/or an identity verification platform (e.g., as described in connection with FIGS. 1A-2B).

As shown by reference number 305, a machine learning model may be trained using a set of observations. The set of observations may be obtained and/or input from historical data, such as data gathered during one or more processes described herein. For example, the set of observations may include data gathered from user interaction with and/or user input to complete a task (e.g., behavioral data), as described elsewhere herein. In some implementations, the machine learning system may receive the set of observations (e.g., as input) from an identity verification platform, a client device using sensors to obtain the behavioral data, a server device that has obtained the behavioral data, and/or the like.

As shown by reference number 310, a feature set may be derived from the set of observations. The feature set may include a set of variable types. A variable type may be referred to as a feature. A specific observation may include a set of variable values corresponding to the set of variable types. A set of variable values may be specific to an observation. In some cases, different observations may be associated with different sets of variable values, sometimes referred to as feature values. In some implementations, the machine learning system may determine variable values for a specific observation based on input received from the identity verification platform. For example, the machine learning system may identify a feature set (e.g., one or more features and/or corresponding feature values) from structured data input to the machine learning system, such as by extracting data from a particular column of a table, extracting data from a particular field of a form, extracting data from a particular field of a message, extracting data received in a structured data format, and/or the like. In some implementations, the machine learning system may determine features (e.g., variables types) for a feature set based on input received from the identity verification platform, such as by extracting or generating a name for a column, extracting or generating a name for a field of a form and/or a message, extracting or generating a name based on a structured data format, and/or the like. Additionally, or alternatively, the machine learning system may receive input from an operator to determine features and/or feature values. In some implementations, the machine learning system may perform natural language processing and/or another feature identification technique to extract features (e.g., variable types) and/or feature values (e.g., variable values) from text (e.g., unstructured data) input to the machine learning system, such as by identifying keywords and/or values associated with those keywords from the text.

As an example, a feature set for a set of observations may include a first feature of acceleration data, a second feature of pressure data, a third feature of time data, and so on. As shown, for a first observation, the first feature may have a value of 0.00452 m/s², the second feature may have a value of 0.0035 N, the third feature may have a value of 1.305 s, and so on. These features and feature values are provided as examples, and may differ in other examples. For example, the feature set may include one or more of the following features: directional acceleration, force acceleration, direction change, positionality, pressure, time, jiggle, path, speed, and/or the like. In some implementations, the machine learning system may pre-process and/or perform dimensionality reduction to reduce the feature set and/or combine features of the feature set to a minimum feature set. A machine learning model may be trained on the minimum feature set, thereby conserving resources of the machine learning system (e.g., processing resources, memory resources, and/or the like) used to train the machine learning model.

As shown by reference number 315, the set of observations may be associated with a target variable type. The target variable type may represent a variable having a numeric value (e.g., an integer value, a floating point value, and/or the like), may represent a variable having a numeric value that falls within a range of values or has some discrete possible values, may represent a variable that is selectable from one of multiple options (e.g., one of multiples classes, classifications, labels, and/or the like), may represent a variable having a Boolean value (e.g., 0 or 1, True or False, Yes or No), and/or the like. A target variable type may be associated with a target variable value, and a target variable value may be specific to an observation. In some cases, different observations may be associated with different target variable values.

The target variable may represent a value that a machine learning model is being trained to predict, and the feature set may represent the variables that are input to a trained machine learning model to predict a value for the target variable. The set of observations may include target variable values so that the machine learning model can be trained to recognize patterns in the feature set that lead to a target variable value. A machine learning model that is trained to predict a target variable value may be referred to as a supervised learning model, a predictive model, and/or the like. When the target variable type is associated with continuous target variable values (e.g., a range of numbers and/or the like), the machine learning model may employ a regression technique. When the target variable type is associated with categorical target variable values (e.g., classes, labels, and/or the like), the machine learning model may employ a classification technique.

In some implementations, the machine learning model may be trained on a set of observations that do not include a target variable (or that include a target variable, but the machine learning model is not being executed to predict the target variable). This may be referred to as an unsupervised learning model, an automated data analysis model, an automated signal extraction model, and/or the like. In this case, the machine learning model may learn patterns from the set of observations without labeling or supervision, and may provide output that indicates such patterns, such as by using clustering and/or association to identify related groups of items within the set of observations.

As further shown, the machine learning system may partition the set of observations into a training set 320 that includes a first subset of observations, of the set of observations, and a test set 325 that includes a second subset of observations of the set of observations. The training set 320 may be used to train (e.g., fit, tune, and/or the like) the machine learning model, while the test set 325 may be used to evaluate a machine learning model that is trained using the training set 320. For example, for supervised learning, the test set 325 may be used for initial model training using the first subset of observations, and the test set 325 may be used to test whether the trained model accurately predicts target variables in the second subset of observations. In some implementations, the machine learning system may partition the set of observations into the training set 320 and the test set 325 by including a first portion or a first percentage of the set of observations in the training set 320 (e.g., 75%, 80%, or 85%, among other examples) and including a second portion or a second percentage of the set of observations in the test set 325 (e.g., 25%, 20%, or 15%, among other examples). In some implementations, the machine learning system may randomly select observations to be included in the training set 320 and/or the test set 325.

As shown by reference number 330, the machine learning system may train a machine learning model using the training set 320. This training may include executing, by the machine learning system, a machine learning algorithm to determine a set of model parameters based on the training set 320. In some implementations, the machine learning algorithm may include a regression algorithm (e.g., linear regression, logistic regression, and/or the like), which may include a regularized regression algorithm (e.g., Lasso regression, Ridge regression, Elastic-Net regression, and/or the like). Additionally, or alternatively, the machine learning algorithm may include a decision tree algorithm, which may include a tree ensemble algorithm (e.g., generated using bagging and/or boosting), a random forest algorithm, a boosted trees algorithm, and/or the like. A model parameter may include an attribute of a machine learning model that is learned from data input into the model (e.g., the training set 320). For example, for a regression algorithm, a model parameter may include a regression coefficient (e.g., a weight). For a decision tree algorithm, a model parameter may include a decision tree split location, as an example.

As shown by reference number 335, the machine learning system may use one or more hyperparameter sets 340 to tune the machine learning model. A hyperparameter may include a structural parameter that controls execution of a machine learning algorithm by the machine learning system, such as a constraint applied to the machine learning algorithm. Unlike a model parameter, a hyperparameter is not learned from data input into the model. An example hyperparameter for a regularized regression algorithm includes a strength (e.g., a weight) of a penalty applied to a regression coefficient to mitigate overfitting of the machine learning model to the training set 320. The penalty may be applied based on a size of a coefficient value (e.g., for Lasso regression, such as to penalize large coefficient values), may be applied based on a squared size of a coefficient value (e.g., for Ridge regression, such as to penalize large squared coefficient values), may be applied based on a ratio of the size and the squared size (e.g., for Elastic-Net regression), may be applied by setting one or more feature values to zero (e.g., for automatic feature selection), and/or the like. Example hyperparameters for a decision tree algorithm include a tree ensemble technique to be applied (e.g., bagging, boosting, a random forest algorithm, a boosted trees algorithm, and/or the like), a number of features to evaluate, a number of observations to use, a maximum depth of each decision tree (e.g., a number of branches permitted for the decision tree), a number of decision trees to include in a random forest algorithm, and/or the like.

To train a machine learning model, the machine learning system may identify a set of machine learning algorithms to be trained (e.g., based on operator input that identifies the one or more machine learning algorithms, based on random selection of a set of machine learning algorithms, and/or the like), and may train the set of machine learning algorithms (e.g., independently for each machine learning algorithm in the set) using the training set 320. The machine learning system may tune each machine learning algorithm using one or more hyperparameter sets 340 (e.g., based on operator input that identifies hyperparameter sets 340 to be used, based on randomly generating hyperparameter values, and/or the like). The machine learning system may train a particular machine learning model using a specific machine learning algorithm and a corresponding hyperparameter set 340. In some implementations, the machine learning system may train multiple machine learning models to generate a set of model parameters for each machine learning model, where each machine learning model corresponds to a different combination of a machine learning algorithm and a hyperparameter set 340 for that machine learning algorithm.

In some implementations, the machine learning system may perform cross-validation when training a machine learning model. Cross validation can be used to obtain a reliable estimate of machine learning model performance using only the training set 320, and without using the test set 325, such as by splitting the training set 320 into a number of groups (e.g., based on operator input that identifies the number of groups, based on randomly selecting a number of groups, and/or the like) and using those groups to estimate model performance. For example, using k-fold cross-validation, observations in the training set 320 may be split into k groups (e.g., in order or at random). For a training procedure, one group may be marked as a hold-out group, and the remaining groups may be marked as training groups. For the training procedure, the machine learning system may train a machine learning model on the training groups and then test the machine learning model on the hold-out group to generate a cross-validation score. The machine learning system may repeat this training procedure using different hold-out groups and different test groups to generate a cross-validation score for each training procedure. In some implementations, the machine learning system may independently train the machine learning model k times, with each individual group being used as a hold-out group once and being used as a training group k−1 times. The machine learning system may combine the cross-validation scores for each training procedure to generate an overall cross-validation score for the machine learning model. The overall cross-validation score may include, for example, an average cross-validation score (e.g., across all training procedures), a standard deviation across cross-validation scores, a standard error across cross-validation scores, and/or the like.

In some implementations, the machine learning system may perform cross-validation when training a machine learning model by splitting the training set into a number of groups (e.g., based on operator input that identifies the number of groups, based on randomly selecting a number of groups, and/or the like). The machine learning system may perform multiple training procedures and may generate a cross-validation score for each training procedure. The machine learning system may generate an overall cross-validation score for each hyperparameter set 340 associated with a particular machine learning algorithm. The machine learning system may compare the overall cross-validation scores for different hyperparameter sets 340 associated with the particular machine learning algorithm, and may select the hyperparameter set 340 with the best (e.g., highest accuracy, lowest error, closest to a desired threshold, and/or the like) overall cross-validation score for training the machine learning model. The machine learning system may then train the machine learning model using the selected hyperparameter set 340, without cross-validation (e.g., using all of data in the training set 320 without any hold-out groups), to generate a single machine learning model for a particular machine learning algorithm. The machine learning system may then test this machine learning model using the test set 325 to generate a performance score, such as a mean squared error (e.g., for regression), a mean absolute error (e.g., for regression), an area under receiver operating characteristic curve (e.g., for classification), and/or the like. If the machine learning model performs adequately (e.g., with a performance score that satisfies a threshold), then the machine learning system may store that machine learning model as a trained machine learning model 345 to be used to analyze new observations, as described below in connection with FIG. 4.

In some implementations, the machine learning system may perform cross-validation, as described above, for multiple machine learning algorithms (e.g., independently), such as a regularized regression algorithm, different types of regularized regression algorithms, a decision tree algorithm, different types of decision tree algorithms, and/or the like. Based on performing cross-validation for multiple machine learning algorithms, the machine learning system may generate multiple machine learning models, where each machine learning model has the best overall cross-validation score for a corresponding machine learning algorithm. The machine learning system may then train each machine learning model using the entire training set 320 (e.g., without cross-validation), and may test each machine learning model using the test set 325 to generate a corresponding performance score for each machine learning model. The machine learning model may compare the performance scores for each machine learning model, and may select the machine learning model with the best (e.g., highest accuracy, lowest error, closest to a desired threshold, and/or the like) performance score as the trained machine learning model 345.

As indicated above, FIG. 3 is provided as an example. Other examples may differ from what is described in connection with FIG. 3. For example, the machine learning model may be trained using a different process than what is described in connection with FIG. 3. Additionally, or alternatively, the machine learning model may employ a different machine learning algorithm than what is described in connection with FIG. 3, such as a Bayesian estimation algorithm, a k-nearest neighbor algorithm, an a priori algorithm, a k-means algorithm, a support vector machine algorithm, a neural network algorithm (e.g., a convolutional neural network algorithm), a deep learning algorithm, and/or the like.

FIG. 4 is a diagram illustrating an example 400 of applying a trained machine learning model to a new observation. The new observation may be input to a machine learning system that stores a trained machine learning model 405. In some implementations, the trained machine learning model 405 may be the trained machine learning model 345 described above in connection with FIG. 3. The machine learning system may include a computing device, a server, a cloud computing environment, and/or the like, such as an identity verification platform, a client device, a server device, and/or the like.

As shown by reference number 410, the machine learning system may receive a new observation (or a set of new observations), and may input the new observation to the machine learning model 405. As shown, the new observation may include a first feature of acceleration, a second feature of pressure, a third feature of time, and so on, as an example. The machine learning system may apply the trained machine learning model 405 to the new observation to generate an output (e.g., a result). The type of output may depend on the type of machine learning model and/or the type of machine learning task being performed. For example, the output may include a predicted (e.g., estimated) value of target variable (e.g., a value within a continuous range of values, a discrete value, a label, a class, a classification, and/or the like), such as when supervised learning is employed. Additionally, or alternatively, the output may include information that identifies a cluster to which the new observation belongs, information that indicates a degree of similarity between the new observation and one or more prior observations (e.g., which may have previously been new observations input to the machine learning model and/or observations used to train the machine learning model), and/or the like, such as when unsupervised learning is employed.

In some implementations, the trained machine learning model 405 may predict a value of 0 for the target variable of “Identity Verification” for the new observation, as shown by reference number 415. Based on this prediction (e.g., based on the value having a particular label/classification, based on the value satisfying or failing to satisfy a threshold, and/or the like), the machine learning system may provide a recommendation, such as to block access to a resource, request additional data to verify an identity, and/or the like. Additionally, or alternatively, the machine learning system may perform an automated action and/or may cause an automated action to be performed (e.g., by instructing another device to perform the automated action). As another example, if the machine learning system were to predict a value of 1 for the target variable of “Identity Verification,” then the machine learning system may provide a different recommendation (e.g., allow access to a resource) and/or may perform or cause performance of a different automated action. In some implementations, the recommendation and/or the automated action may be based on the target variable value having a particular label (e.g., classification, categorization, and/or the like), may be based on whether the target variable value satisfies one or more threshold (e.g., whether the target variable value is greater than a threshold, is less than a threshold, is equal to a threshold, falls within a range of threshold values, and/or the like), and/or the like.

In some implementations, the trained machine learning model 405 may classify (e.g., cluster) the new observation in a cluster, as shown by reference number 420. The observations within a cluster may have a threshold degree of similarity. Based on classifying the new observation in the cluster, the machine learning system may provide a recommendation. Additionally, or alternatively, the machine learning system may perform an automated action and/or may cause an automated action to be performed (e.g., by instructing another device to perform the automated action). As another example, if the machine learning system were to classify the new observation in a cluster, then the machine learning system may provide a different recommendation and/or may perform or cause performance of a different automated action.

In this way, the machine learning system may apply a rigorous and automated process to perform identity verification. The machine learning system enables recognition and/or identification of tens, hundreds, thousands, or millions of features and/or feature values for tens, hundreds, thousands, or millions of observations, thereby increasing an accuracy and consistency of identity verification relative to requiring computing resources to be allocated for tens, hundreds, or thousands of operators to manually perform identity verification using the features or feature values.

As indicated above, FIG. 4 is provided as an example. Other examples may differ from what is described in connection with FIG. 4.

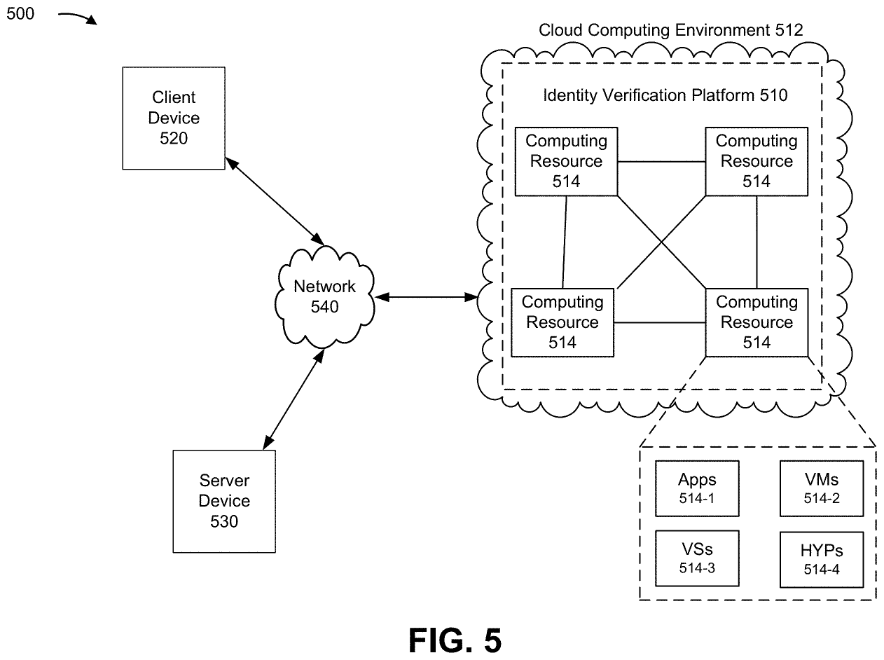

FIG. 5 is a diagram of an example environment 500 in which systems and/or methods, described herein, may be implemented. As shown in FIG. 5, environment 500 may include an identity verification platform 510, a client device 520, a server device 530, and/or a network 540. Devices of environment 500 may interconnect via wired connections, wireless connections, or a combination of wired and wireless connections.

Identity verification platform 510 includes one or more devices that perform identity verification based on receiving input and/or behavioral data. In some implementations, identity verification platform 510 may be designed to be modular such that certain software components may be swapped in or out depending on a particular need. As such, identity verification platform 510 may be easily and/or quickly reconfigured for different uses. In some implementations, identity verification platform 510 may receive information from and/or transmit information to one or more client devices 520 and/or server devices 530.

In some implementations, as shown, identity verification platform 510 may be hosted in a cloud computing environment 512. Notably, while implementations described herein describe identity verification platform 510 as being hosted in cloud computing environment 512, in some implementations, identity verification platform 510 may be non-cloud-based (i.e., may be implemented outside of a cloud computing environment) or may be partially cloud-based.

Cloud computing environment 512 includes an environment that hosts identity verification platform 510. Cloud computing environment 512 may provide computation, software, data access, storage, etc. services that do not require end-user knowledge of a physical location and configuration of system(s) and/or device(s) that host identity verification platform 510. As shown, cloud computing environment 512 may include a group of computing resources 514 (referred to collectively as “computing resources 514” and individually as “computing resource 514”).

Computing resource 514 includes one or more personal computers, workstation computers, server devices, and/or other types of computation and/or communication devices. In some implementations, computing resource 514 may host identity verification platform 510. The cloud resources may include compute instances executing in computing resource 514, storage devices provided in computing resource 514, data transfer devices provided by computing resource 514, etc. In some implementations, computing resource 514 may communicate with other computing resources 514 via wired connections, wireless connections, or a combination of wired and wireless connections.

As further shown in FIG. 5, computing resource 514 includes a group of cloud resources, such as one or more applications (“APPs”) 514-1, one or more virtual machines (“VMs”) 514-2, virtualized storage (“VSs”) 514-3, one or more hypervisors (“HYPs”) 514-4, and/or the like.

Application 514-1 includes one or more software applications that may be provided to or accessed by client device 520. Application 514-1 may eliminate a need to install and execute the software applications on client device 520. For example, application 514-1 may include software associated with identity verification platform 510 and/or any other software capable of being provided via cloud computing environment 512. In some implementations, one application 514-1 may send/receive information to/from one or more other applications 514-1, via virtual machine 514-2.

Virtual machine 514-2 includes a software implementation of a machine (e.g., a computer) that executes programs like a physical machine. Virtual machine 514-2 may be either a system virtual machine or a process virtual machine, depending upon use and degree of correspondence to any real machine by virtual machine 514-2. A system virtual machine may provide a complete system platform that supports execution of a complete operating system (“OS”). A process virtual machine may execute a single program and may support a single process. In some implementations, virtual machine 514-2 may execute on behalf of a user (e.g., a user of client device 520, a user of server device 530, and/or an operator of identity verification platform 510), and may manage infrastructure of cloud computing environment 512, such as data management, synchronization, or long-duration data transfers.

Virtualized storage 514-3 includes one or more storage systems and/or one or more devices that use virtualization techniques within the storage systems or devices of computing resource 514. In some implementations, within the context of a storage system, types of virtualizations may include block virtualization and file virtualization. Block virtualization may refer to abstraction (or separation) of logical storage from physical storage so that the storage system may be accessed without regard to physical storage or heterogeneous structure. The separation may permit administrators of the storage system flexibility in how the administrators manage storage for end users. File virtualization may eliminate dependencies between data accessed at a file level and a location where files are physically stored. This may enable optimization of storage use, server consolidation, and/or performance of non-disruptive file migrations.

Hypervisor 514-4 may provide hardware virtualization techniques that allow multiple operating systems (e.g., “guest operating systems”) to execute concurrently on a host computer, such as computing resource 514. Hypervisor 514-4 may present a virtual operating platform to the guest operating systems and may manage the execution of the guest operating systems. Multiple instances of a variety of operating systems may share virtualized hardware resources.

Client device 520 includes one or more devices capable of receiving, generating, storing, processing, and/or providing information, such as behavioral data described herein. For example, client device 520 may include a mobile phone (e.g., a smart phone, a radiotelephone, etc.), a laptop computer, a tablet computer, a desktop computer, a handheld computer, a gaming device, a wearable communication device (e.g., a smart wristwatch, a pair of smart eyeglasses, etc.), or a similar type of device. In some implementations, client device 520 may receive information from and/or transmit information to identity verification platform 510 and/or server device 530.

Server device 530 includes one or more devices capable of receiving, generating, storing, processing, and/or providing information, such as information described herein. For example, server device 530 may include a laptop computer, a tablet computer, a desktop computer, a server device, a group of server devices, or a similar type of device, associated with a merchant, a financial institution, and/or the like. In some implementations, server device 530 may receive information from and/or transmit information to client device 520 and/or identity verification platform 510.

Network 540 includes one or more wired and/or wireless networks. For example, network 540 may include a cellular network (e.g., a fifth generation (5G) network, a long-term evolution (LTE) network, a third generation (3G) network, a code division multiple access (CDMA) network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, and/or the like, and/or a combination of these or other types of networks.

The number and arrangement of devices and networks shown in FIG. 5 are provided as one or more examples. In practice, there may be additional devices and/or networks, fewer devices and/or networks, different devices and/or networks, or differently arranged devices and/or networks than those shown in FIG. 5. Furthermore, two or more devices shown in FIG. 5 may be implemented within a single device, or a single device shown in FIG. 5 may be implemented as multiple, distributed devices. Additionally, or alternatively, a set of devices (e.g., one or more devices) of environment 500 may perform one or more functions described as being performed by another set of devices of environment 500.

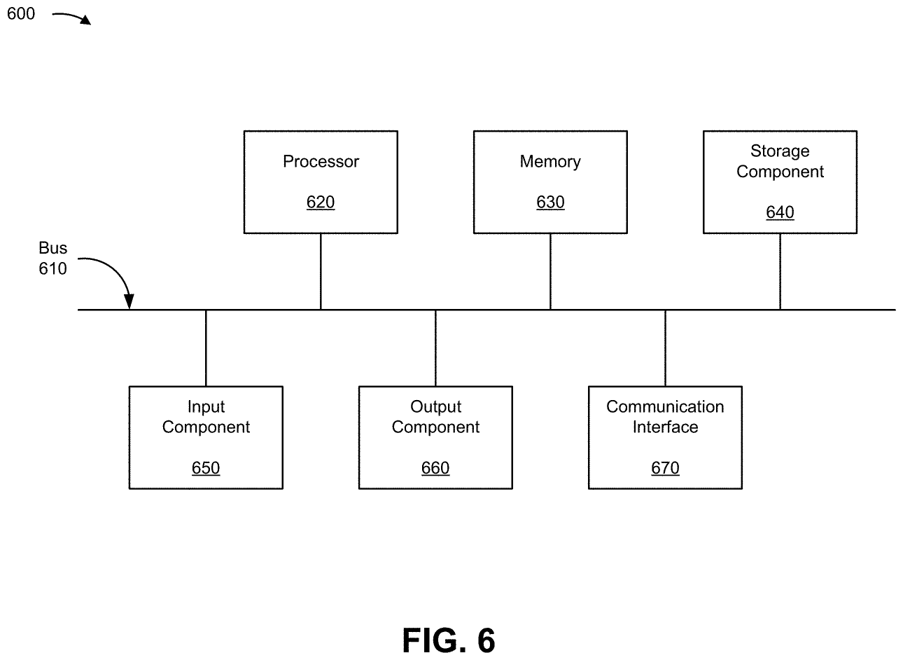

FIG. 6 is a diagram of example components of a device 600. Device 600 may correspond to identity verification platform 510, client device 520, and/or server device 530. In some implementations, identity verification platform 510, client device 520, and/or server device 530 may include one or more devices 600 and/or one or more components of device 600. As shown in FIG. 6, device 600 may include a bus 610, a processor 620, a memory 630, a storage component 640, an input component 650, an output component 660, and a communication interface 670.

Bus 610 includes a component that permits communication among multiple components of device 600. Processor 620 is implemented in hardware, firmware, and/or a combination of hardware and software. Processor 620 is a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some implementations, processor 620 includes one or more processors capable of being programmed to perform a function. Memory 630 includes a random access memory (RAM), a read only memory (ROM), and/or another type of dynamic or static storage device (e.g., a flash memory, a magnetic memory, and/or an optical memory) that stores information and/or instructions for use by processor 620.

Storage component 640 stores information and/or software related to the operation and use of device 600. For example, storage component 640 may include a hard disk (e.g., a magnetic disk, an optical disk, and/or a magneto-optic disk), a solid state drive (SSD), a compact disc (CD), a digital versatile disc (DVD), a floppy disk, a cartridge, a magnetic tape, and/or another type of non-transitory computer-readable medium, along with a corresponding drive.

Input component 650 includes a component that permits device 600 to receive information, such as via user input (e.g., a touch screen display, a keyboard, a keypad, a mouse, a button, a switch, and/or a microphone). Additionally, or alternatively, input component 650 may include a component for determining location (e.g., a global positioning system (GPS) component) and/or a sensor (e.g., an accelerometer, a gyroscope, an actuator, another type of positional or environmental sensor, and/or the like). Output component 660 includes a component that provides output information from device 600 (via, e.g., a display, a speaker, a haptic feedback component, an audio or visual indicator, and/or the like).

Communication interface 670 includes a transceiver-like component (e.g., a transceiver, a separate receiver, a separate transmitter, and/or the like) that enables device 600 to communicate with other devices, such as via a wired connection, a wireless connection, or a combination of wired and wireless connections. Communication interface 670 may permit device 600 to receive information from another device and/or provide information to another device. For example, communication interface 670 may include an Ethernet interface, an optical interface, a coaxial interface, an infrared interface, a radio frequency (RF) interface, a universal serial bus (USB) interface, a Wi-Fi interface, a cellular network interface, and/or the like.

Device 600 may perform one or more processes described herein. Device 600 may perform these processes based on processor 620 executing software instructions stored by a non-transitory computer-readable medium, such as memory 630 and/or storage component 640. As used herein, the term “computer-readable medium” refers to a non-transitory memory device. A memory device includes memory space within a single physical storage device or memory space spread across multiple physical storage devices.

Software instructions may be read into memory 630 and/or storage component 640 from another computer-readable medium or from another device via communication interface 670. When executed, software instructions stored in memory 630 and/or storage component 640 may cause processor 620 to perform one or more processes described herein. Additionally, or alternatively, hardware circuitry may be used in place of or in combination with software instructions to perform one or more processes described herein. Thus, implementations described herein are not limited to any specific combination of hardware circuitry and software.

The number and arrangement of components shown in FIG. 6 are provided as an example. In practice, device 600 may include additional components, fewer components, different components, or differently arranged components than those shown in FIG. 6. Additionally, or alternatively, a set of components (e.g., one or more components) of device 600 may perform one or more functions described as being performed by another set of components of device 600.

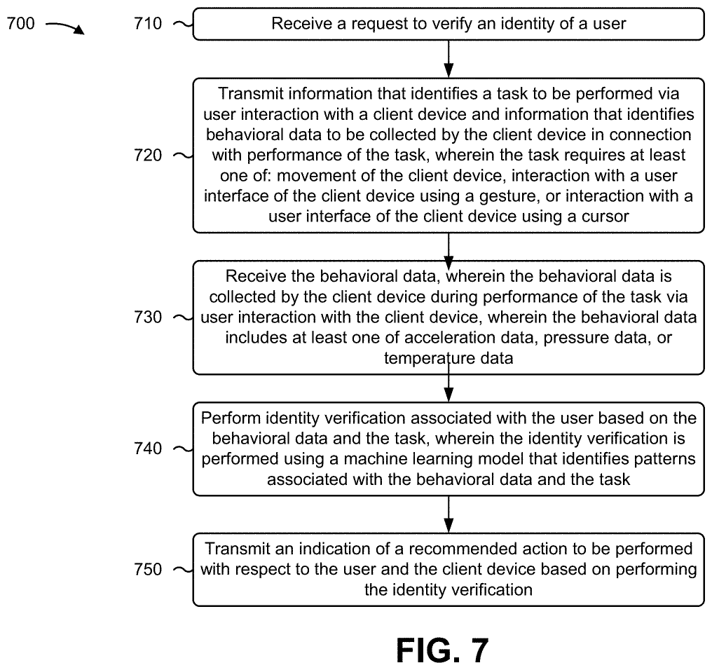

FIG. 7 is a flow chart of an example process 700 for performing identity verification using task-based behavioral biometrics. In some implementations, one or more process blocks of FIG. 7 may be performed by a system (e.g., identity verification platform 510). In some implementations, one or more process blocks of FIG. 7 may be performed by another device or a group of devices separate from or including the system, such as a client device (e.g., client device 520), a server device (e.g., server device 530), and/or the like.

As shown in FIG. 7, process 700 may include receiving a request to verify an identity of a user (block 710). For example, the system (e.g., using computing resource 514, processor 620, memory 630, storage component 640, input component 650, output component 660, communication interface 670, and/or the like) may receive a request to verify an identity of a user, as described above.

As further shown in FIG. 7, process 700 may include transmitting information that identifies a task to be performed via user interaction with a client device and information that identifies behavioral data to be collected by the client device in connection with performance of the task, wherein the task requires at least one of: movement of the client device, interaction with a user interface of the client device using a gesture, or interaction with a user interface of the client device using a cursor (block 720). For example, the system (e.g., using computing resource 514, processor 620, memory 630, storage component 640, input component 650, output component 660, communication interface 670, and/or the like) may transmit information that identifies a task to be performed via user interaction with a client device and information that identifies behavioral data to be collected by the client device in connection with performance of the task, as described above. In some implementations, the task requires at least one of: movement of the client device, interaction with a user interface of the client device using a gesture, or interaction with a user interface of the client device using a cursor.

As further shown in FIG. 7, process 700 may include receiving the behavioral data, wherein the behavioral data is collected by the client device during performance of the task via user interaction with the client device, wherein the behavioral data includes at least one of acceleration data, pressure data, or temperature data (block 730). For example, the system (e.g., using computing resource 514, processor 620, memory 630, storage component 640, input component 650, output component 660, communication interface 670, and/or the like) may receive the behavioral data, as described above. In some implementations, the behavioral data is collected by the client device during performance of the task via user interaction with the client device. In some implementations, the behavioral data includes at least one of acceleration data, pressure data, or temperature data.

As further shown in FIG. 7, process 700 may include performing identity verification associated with the user based on the behavioral data and the task, wherein the identity verification is performed using a machine learning model that identifies patterns associated with the behavioral data and the task (block 740). For example, the system (e.g., using computing resource 514, processor 620, memory 630, storage component 640, input component 650, output component 660, communication interface 670, and/or the like) may perform identity verification associated with the user based on the behavioral data and the task, as described above. In some implementations, the identity verification is performed using a machine learning model that identifies patterns associated with the behavioral data and the task.

As further shown in FIG. 7, process 700 may include transmitting an indication of a recommended action to be performed with respect to the user and the client device based on performing the identity verification (block 750). For example, the system (e.g., using computing resource 514, processor 620, memory 630, storage component 640, input component 650, output component 660, communication interface 670, and/or the like) may transmit an indication of a recommended action to be performed with respect to the user and the client device based on performing the identity verification, as described above.

Process 700 may include additional implementations, such as any single implementation or any combination of implementations described below and/or in connection with one or more other processes described elsewhere herein.

In a first implementation, the task may involve movement of the client device, and the behavioral data may include two or more of: the acceleration data, the pressure data, or the temperature data.

In a second implementation, alone or in combination with the first implementation, the task may comprise a formation of a signature through one of: movement of the client device, interaction with the user interface of the client device using the gesture, or interaction with the user interface of the client device using the cursor, and the behavioral data may include the acceleration data obtained from the formation of the signature.

In a third implementation, alone or in combination with one or more of the first and second implementations, the task may comprise responding to a graphic being displayed on the client device by shaking the client device through one of: movement of the client device, interaction with the user interface of the client device using the gesture, or interaction with the user interface of the client device using the cursor.

In a fourth implementation, alone or in combination with one or more of the first through third implementations, the task may require interaction with the user interface of the client device using the gesture or the cursor, and the behavioral data is collected while the task is being performed.

In a fifth implementation, alone or in combination with one or more of the first through fourth implementations, the task may involve completing a maze through one of: movement of the client device, interaction with the user interface of the client device using the gesture, or interaction with the user interface of the client device using the cursor, and the behavioral data is associated with completing the maze.

In a sixth implementation, alone or in combination with one or more of the first through fifth implementations, the task may involve identifying a location through interaction with a map displayed on the client device, and the behavioral data is associated with the interaction with the map.

Although FIG. 7 shows example blocks of process 700, in some implementations, process 700 may include additional blocks, fewer blocks, different blocks, or differently arranged blocks than those depicted in FIG. 7. Additionally, or alternatively, two or more of the blocks of process 700 may be performed in parallel.

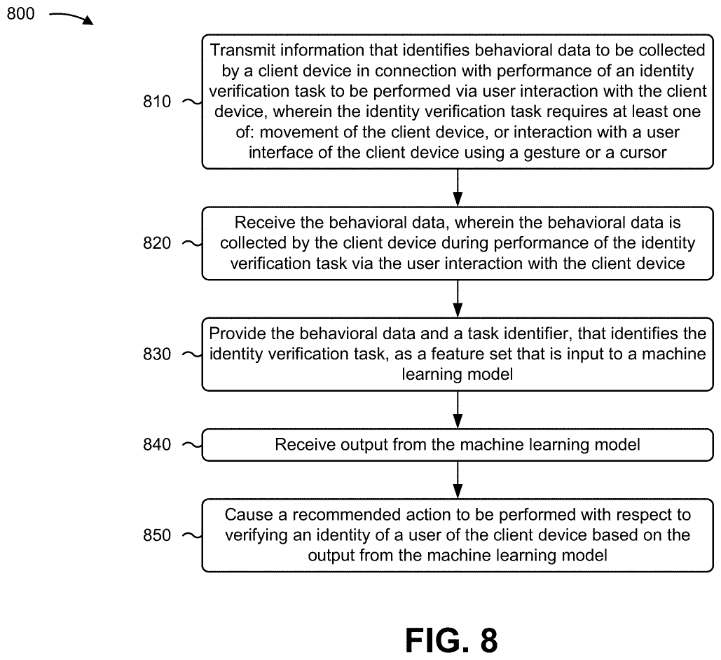

FIG. 8 is a flow chart of an example process 800 for performing identity verification using task-based behavioral biometrics. In some implementations, one or more process blocks of FIG. 8 may be performed by a system (e.g., identity verification platform 510). In some implementations, one or more process blocks of FIG. 8 may be performed by another device or a group of devices separate from or including the system, such as a client device (e.g., client device 520), a server device (e.g., server device 530), and/or the like.

As shown in FIG. 8, process 800 may include transmitting information that identifies behavioral data to be collected by a client device in connection with performance of an identity verification task to be performed via user interaction with the client device, wherein the identity verification task requires at least one of: movement of the client device, or interaction with a user interface of the client device using a gesture or a cursor (block 810). For example, the system (e.g., using computing resource 514, processor 620, memory 630, storage component 640, input component 650, output component 660, communication interface 670, and/or the like) may transmit information that identifies behavioral data to be collected by a client device in connection with performance of an identity verification task to be performed via user interaction with the client device, as described above. In some implementations, the identity verification task requires at least one of movement of the client device, or interaction with a user interface of the client device using a gesture or a cursor.

As further shown in FIG. 8, process 800 may include receiving the behavioral data, wherein the behavioral data is collected by the client device during performance of the identity verification task via the user interaction with the client device (block 820). For example, the system (e.g., using computing resource 514, processor 620, memory 630, storage component 640, input component 650, output component 660, communication interface 670, and/or the like) may receive the behavioral data, as described above. In some implementations, the behavioral data is collected by the client device during performance of the identity verification task via the user interaction with the client device.

As further shown in FIG. 8, process 800 may include providing the behavioral data and a task identifier, that identifies the identity verification task, as a feature set that is input to a machine learning model (block 830). For example, the system (e.g., using computing resource 514, processor 620, memory 630, storage component 640, input component 650, output component 660, communication interface 670, and/or the like) may provide the behavioral data and a task identifier, that identifies the identity verification task, as a feature set that is input to a machine learning model, as described above.

As further shown in FIG. 8, process 800 may include receiving output from the machine learning model (block 840). For example, the system (e.g., using computing resource 514, processor 620, memory 630, storage component 640, input component 650, output component 660, communication interface 670, and/or the like) may receive output from the machine learning model, as described above.

As further shown in FIG. 8, process 800 may include causing a recommended action to be performed with respect to verifying an identity of a user of the client device based on the output from the machine learning model (block 850). For example, the system (e.g., using computing resource 514, processor 620, memory 630, storage component 640, input component 650, output component 660, communication interface 670, and/or the like) may cause a recommended action to be performed with respect to verifying an identity of a user of the client device based on the output from the machine learning model, as described above.

Process 800 may include additional implementations, such as any single implementation or any combination of implementations described below and/or in connection with one or more other processes described elsewhere herein.

In a first implementation, the behavioral data may relate to at least one of: position, speed, direction, directional acceleration, force acceleration, pressure, or temperature.

In a second implementation, alone or in combination with the first implementation, the behavioral data may include multiple parameters that are included in the feature set that is input to the machine learning model.

In a third implementation, alone or in combination with one or more of the first and second implementations, the identity verification task may include answering a knowledge-based authentication question by moving the client device or interacting with the user interface of the client device using the gesture or the cursor.

In a fourth implementation, alone or in combination with one or more of the first through third implementations, process 800 may include receiving an answer to the knowledge-based authentication question and the recommended action is based on the answer to the knowledge-based authentication question.

In a fifth implementation, alone or in combination with one or more of the first through fourth implementations, the recommended action may include one of: approving access to a resource, denying access to the resource, sending an additional task, or requesting additional data from the client device.

In a sixth implementation, alone or in combination with one or more of the first through fifth implementations, the output from the machine learning model is determined based on a degree of similarity of the feature set and at least one of: one or more other feature sets associated with the user, or a threshold number of feature sets analyzed in connection with the identity verification task or one or more other tasks.

Although FIG. 8 shows example blocks of process 800, in some implementations, process 800 may include additional blocks, fewer blocks, different blocks, or differently arranged blocks than those depicted in FIG. 8. Additionally, or alternatively, two or more of the blocks of process 800 may be performed in parallel.

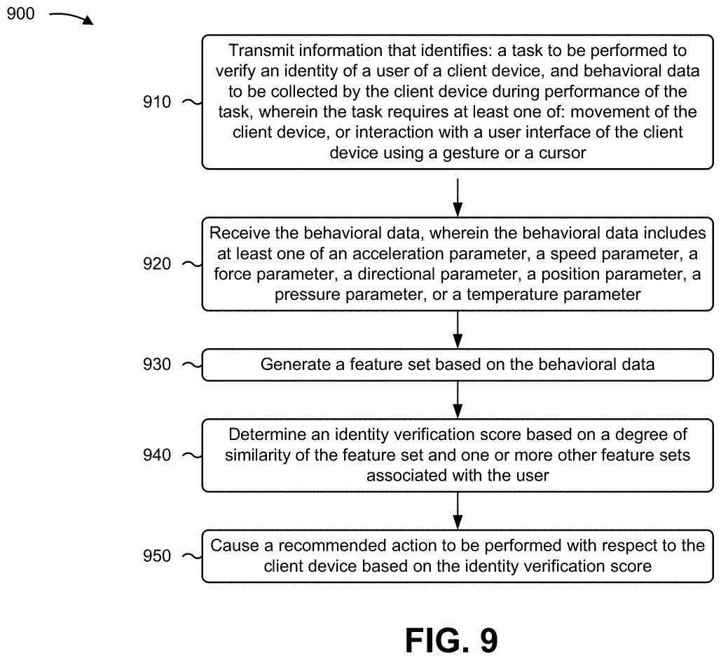

FIG. 9 is a flow chart of an example process 900 for identity verification using task-based behavioral biometrics. In some implementations, one or more process blocks of FIG. 9 may be performed by a system (e.g., identity verification platform 510). In some implementations, one or more process blocks of FIG. 9 may be performed by another device or a group of devices separate from or including the system, such as a client device (e.g., client device 520), a server device (e.g., server device 530), and/or the like.

As shown in FIG. 9, process 900 may include transmitting information that identifies: a task to be performed to verify an identity of a user of a client device, and behavioral data to be collected by the client device during performance of the task, wherein the task requires at least one of: movement of the client device, or interaction with a user interface of the client device using a gesture or a cursor (block 910). For example, the system (e.g., using computing resource 514, processor 620, memory 630, storage component 640, input component 650, output component 660, communication interface 670, and/or the like) may transmit information that identifies, as described above. In some implementations, the task requires at least one of movement of the client device, or interaction with a user interface of the client device using a gesture or a cursor.

As further shown in FIG. 9, process 900 may include receiving the behavioral data, wherein the behavioral data includes at least one of an acceleration parameter, a speed parameter, a force parameter, a directional parameter, a position parameter, a pressure parameter, or a temperature parameter (block 920). For example, the system (e.g., using computing resource 514, processor 620, memory 630, storage component 640, input component 650, output component 660, communication interface 670, and/or the like) may receive the behavioral data, as described above. In some implementations, the behavioral data includes at least one of an acceleration parameter, a speed parameter, a force parameter, a directional parameter, a position parameter, a pressure parameter, or a temperature parameter.

As further shown in FIG. 9, process 900 may include generating a feature set based on the behavioral data (block 930). For example, the system (e.g., using computing resource 514, processor 620, memory 630, storage component 640, input component 650, output component 660, communication interface 670, and/or the like) may generate a feature set based on the behavioral data, as described above.

As further shown in FIG. 9, process 900 may include determining an identity verification score based on a degree of similarity of the feature set and one or more other feature sets associated with the user (block 940). For example, the system (e.g., using computing resource 514, processor 620, memory 630, storage component 640, input component 650, output component 660, communication interface 670, and/or the like) may determine an identity verification score based on a degree of similarity of the feature set and one or more other feature sets associated with the user, as described above.

As further shown in FIG. 9, process 900 may include causing a recommended action to be performed with respect to the client device based on the identity verification score (block 950). For example, the system (e.g., using computing resource 514, processor 620, memory 630, storage component 640, input component 650, output component 660, communication interface 670, and/or the like) may cause a recommended action to be performed with respect to the client device based on the identity verification score, as described above.

For example, the system (e.g., using computing resource 514, processor 620, memory 630, storage component 640, input component 650, output component 660, communication interface 670, and/or the like) may transmit information that causes the client device to display a visual associated with the task, as described above.

Process 900 may include additional implementations, such as any single implementation or any combination of implementations described below and/or in connection with one or more other processes described elsewhere herein.

In a first implementation, the task may be selected from a set of tasks and the set of tasks may comprise related tasks.

In a second implementation, alone or in combination with the first implementation, process 900 may include transmitting information that causes the client device to display a visual associated with the task.

In a third implementation, alone or in combination with one or more of the first and second implementations, the task may include answering a knowledge-based authentication question by moving the client device or interacting with the user interface of the client device using the gesture or the cursor.

In a fourth implementation, alone or in combination with one or more of the first through third implementations may include receiving an answer to the knowledge-based authentication question and the recommended action may be based on the answer to the knowledge-based authentication question.

In a fifth implementation, alone or in combination with one or more of the first through fourth implementations, the recommended action may include one of: approving submission of information, denying submission of information, approving a transaction, denying a transaction, sending an additional task, or requesting additional data from the client device.

Although FIG. 9 shows example blocks of process 900, in some implementations, process 900 may include additional blocks, fewer blocks, different blocks, or differently arranged blocks than those depicted in FIG. 9. Additionally, or alternatively, two or more of the blocks of process 900 may be performed in parallel.

The foregoing disclosure provides illustration and description, but is not intended to be exhaustive or to limit the implementations to the precise form disclosed. Modifications and variations may be made in light of the above disclosure or may be acquired from practice of the implementations.

As used herein, the term “component” is intended to be broadly construed as hardware, firmware, or a combination of hardware and software.

Some implementations are described herein in connection with thresholds. As used herein, satisfying a threshold may, depending on the context, refer to a value being greater than the threshold, more than the threshold, higher than the threshold, greater than or equal to the threshold, less than the threshold, fewer than the threshold, lower than the threshold, less than or equal to the threshold, equal to the threshold, or the like.

Certain user interfaces have been described herein and/or shown in the figures. A user interface may include a graphical user interface, a non-graphical user interface, a text-based user interface, and/or the like. A user interface may provide information for display. In some implementations, a user may interact with the information, such as by providing input via an input component of a device that provides the user interface for display. In some implementations, a user interface may be configurable by a device and/or a user (e.g., a user may change the size of the user interface, information provided via the user interface, a position of information provided via the user interface, etc.). Additionally, or alternatively, a user interface may be pre-configured to a standard configuration, a specific configuration based on a type of device on which the user interface is displayed, and/or a set of configurations based on capabilities and/or specifications associated with a device on which the user interface is displayed.

It will be apparent that systems and/or methods described herein may be implemented in different forms of hardware, firmware, or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be designed to implement the systems and/or methods based on the description herein.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, a combination of related and unrelated items, etc.), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method, comprising:
receiving, by a system, a request to verify an identity of a user;
transmitting, by the system, information that identifies a task to be performed via user interaction with a client device and information that identifies behavioral data to be collected by the client device in connection with performance of the task,
wherein the task requires at least one of:
movement of the client device,
interaction with a user interface of the client device using a gesture, or
interaction with a user interface of the client device using a cursor;
receiving, by the system, the behavioral data, wherein the behavioral data is collected by the client device during performance of the task via user interaction with the client device,
wherein the behavioral data includes at least one of acceleration data, pressure data, or temperature data;
performing, by the system, identity verification associated with the user based on the behavioral data and the task,
wherein the identity verification is performed using a machine learning model that identifies patterns associated with the behavioral data and the task; and
transmitting, by the system, an indication of a recommended action to be performed with respect to the user and the client device based on performing the identity verification.

2. The method of claim 1, wherein the task involves movement of the client device, and wherein the behavioral data includes two or more of the acceleration data, the pressure data, or the temperature data.

3. The method of claim 1,
wherein the task comprises a formation of a signature through one of: movement of the client device, interaction with the user interface of the client device using the gesture, or interaction with the user interface of the client device using the cursor, and
wherein the behavioral data includes the acceleration data obtained from the formation of the signature.

4. The method of claim 1,
wherein the task comprises responding to a graphic being displayed on the client device by shaking the client device through one of: movement of the client device, interaction with the user interface of the client device using the gesture, or interaction with the user interface of the client device using the cursor.

5. The method of claim 1, wherein the task requires interaction with the user interface of the client device using the gesture or the cursor, and wherein the behavioral data is collected while the task is being performed.

6. The method of claim 1,
wherein the task involves completing a maze through one of: movement of the client device, interaction with the user interface of the client device using the gesture, or interaction with the user interface of the client device using the cursor, and
wherein the behavioral data is associated with completing the maze.

7. The method of claim 1,
wherein the task involves identifying a location through interaction with a map displayed on the client device, and
wherein the behavioral data is associated with the interaction with the map.

8. A system, comprising:
memory; and
one or more processors, communicatively coupled to the memory, configured to:
transmit information that identifies behavioral data to be collected by a client device in connection with performance of an identity verification task to be performed via user interaction with the client device,
wherein the identity verification task requires at least one of:
movement of the client device, or
interaction with a user interface of the client device using a gesture or a cursor;
receive the behavioral data, wherein the behavioral data is collected by the client device during performance of the identity verification task via the user interaction with the client device;
provide the behavioral data and a task identifier, that identifies the identity verification task, as a feature set that is input to a machine learning model;
receive output from the machine learning model; and
cause a recommended action to be performed with respect to verifying an identity of a user of the client device based on the output from the machine learning model.

9. The system of claim 8, wherein the behavioral data relates to at least one of:
position,
speed,
direction,
directional acceleration,
force acceleration,
pressure, or
temperature.

10. The system of claim 8, wherein the behavioral data includes multiple parameters that are included in the feature set that is input to the machine learning model.

11. The system of claim 8, wherein the identity verification task includes answering a knowledge-based authentication question by moving the client device or interacting with the user interface of the client device using the gesture or the cursor.

12. The system of claim 11, wherein the one or more processors are further configured to receive an answer to the knowledge-based authentication question, wherein the recommended action is based on the answer to the knowledge-based authentication question.

13. The system of claim 8, wherein the recommended action includes one of:
approving access, by the client device, to a resource,
denying access, by the client device, to the resource,
sending an additional task, or
requesting additional data from the client device.

14. The system of claim 8, wherein the output from the machine learning model is determined based on a degree of similarity of the feature set and at least one of:
one or more other feature sets associated with the user, or
a threshold number of feature sets analyzed in connection with the identity verification task or one or more other tasks.

15. A non-transitory computer-readable medium storing instructions, the instructions comprising:
one or more instructions that, when executed by one or more processors, cause the one or more processors to:
transmit information that identifies:
a task to be performed to verify an identity of a user of a client device, and
behavioral data to be collected by the client device during performance of the task,
wherein the task requires at least one of:
movement of the client device, or
interaction with a user interface of the client device using a gesture or a cursor;
receive the behavioral data, wherein the behavioral data includes at least one of an acceleration parameter, a speed parameter, a force parameter, a directional parameter, a position parameter, a pressure parameter, or a temperature parameter;
generate a feature set based on the behavioral data;
determine an identity verification score based on a degree of similarity of the feature set and one or more other feature sets associated with the user; and
cause a recommended action to be performed with respect to the client device based on the identity verification score.

16. The non-transitory computer-readable medium of claim 15, wherein the task is selected from a set of tasks,
wherein the set of tasks comprises related tasks.

17. The non-transitory computer-readable medium of claim 15, wherein the one or more instructions, when executed by the one or more processors, further cause the one or more processors to:
transmit information that causes the client device to display a visual associated with the task.

18. The non-transitory computer-readable medium of claim 15, wherein the task includes answering a knowledge-based authentication question by moving the client device or interacting with the user interface of the client device using the gesture or the cursor.

19. The non-transitory computer-readable medium of claim 18, wherein the one or more instructions, when executed by the one or more processors, further cause the one or more processors to:
receive an answer to the knowledge-based authentication question, wherein the recommended action is based on the answer to the knowledge-based authentication question.

20. The non-transitory computer-readable medium of claim 15, wherein the recommended action includes one of:
approving, by the client device, submission of information,
denying, by the client device, submission of information,
approving, by the client device, a transaction,
denying, by the client device, a transaction,
sending an additional task, or
requesting additional data from the client device.
